(19) United States
(12) Patent Application Publication
(10) Pub. No.: US 2022/0081083 A1
(43) Pub. Date: Mar. 17, 2022

(54) Control System for a Cable Operated ROV

(71) Applicants: Shiwei Liu, Lehi, UT (US); Xiaoge Cheng, Beijing (CN); Qiaowei Liu, Lianyungang (CN); Riming Hao, Beijing (CN); Zibo Wang, Zhuhai (CN)

(72) Inventors: Shiwei Liu, Lehi, UT (US); Xiaoge Cheng, Beijing (CN); Qiaowei Liu, Lianyungang (CN); Riming Hao, Beijing (CN); Zibo Wang, Zhuhai (CN)

(21) Appl. No.: 17/462,394

(22) Filed: Aug. 31, 2021

Related U.S. Application Data
(60) Provisional application No. 63/079,971, filed on Sep. 17, 2020.

(51) Int. Cl. B63G 8/00; G05D 1/02; G05D 1/00; B63G 8/14; B63G 8/42; G08C 17/02

(52) U.S. Cl. CPC B63G 8/001; G05D 1/0206; G05D 1/0011; B63G 2008/007; B63G 8/42; G08C 17/02; B63G 8/14

(57) ABSTRACT

The present invention solves the foregoing problems by providing a control system comprising a remote control module in wireless communication with a cable reel module connected to a motor operated cable reel. Advantageously, the remote control module comprises a first user interface for entering instructions and a processor for transmitting the instructions to the cable reel module to extend or retract the cable and thus control the ascent or descent of an ROV attached to the cable. Due to the processor-controlled nature of the control system automated operations of ROV ascent and descent can be realised. Furthermore, the cable reel module itself is provided with a second user interface that can enact a manual override and emergency stop of the ROV motion in the event that the remote control aspect malfunctions or is being operated incorrectly.

### FIELD OF INVENTION

The present invention relates generally to the field of marine control systems. More specifically, the present invention relates to a control system for a remotely operated vehicle (ROV) such as a submersible that enables automated control of the ascent and descent of the ROV, removing the requirement for manual operation of a cable reel.

### BACKGROUND

A Remotely Operated Vehicle (ROV) as referred to herein means an unmanned remotely operated submersible robot. ROVs are often used for deep sea exploration expeditions and research, and work in incredibly critical environmental conditions that humans previously have been unable to access.

One known method of controlling an ROV is by the operation of a cable having one end attached to a ship directly or almost directly above the area to be explored and the other end attached to the ROV. The cable is extended or retracted to control an ascent or descent of the ROV in the water below and proximal to the ship. Examples of ROVs known to have such control mechanisms include but are not limited to self-propelled submersibles, towing-type submersibles, and crawling-type submersibles.

The cable release and retraction is often controlled by a cable winch or cable reel that winds and unwinds the cable to control the depth of the submersible body. However, existing cable reels used for such operations are manually controlled with no automatic extension and release functionality despite commonly available electric cable reels being used. This is inconvenient for researchers and ship operatives using ROVs, as weather conditions aboard ships are often poor and a user must stand at a console and manually control the depth of a submersible that they cannot see or accurately know the position of. This method of ROV control is inefficient, inconvenient, and inflexible. It is within this context that the present invention is provided.

### SUMMARY

The present invention solves the foregoing problems by providing a control system comprising a remote control module in wireless communication with a cable reel module connected to a motor operated cable reel. Advantageously, the remote control module comprises a first user interface for entering instructions and a processor for transmitting the instructions to the cable reel module to extend or retract the cable and thus control the ascent or descent of an ROV attached to the cable. Due to the processor-controlled nature of the control system automated operations of ROV ascent and descent can be realised. Furthermore, the cable reel module itself is provided with a second user interface that can enact a manual override and emergency stop of the ROV motion in the event that the remote control aspect malfunctions or is being operated incorrectly.

A safer and more flexible approach to ROV submersible control is thus realised by the present disclosure.

Thus, according to an aspect of the present invention there is provided a wireless control system for a cable- operated ROV, the control system comprising: a remote control module, the remote control module comprising: a first user interface comprising controls for selecting a motion type for an ROV, the possible motion types including ascent, descent, and stopping motions, and the interface further comprising options for controlling an ascent velocity or descent velocity of the ROV; a first processor configured to interpret control commands received via the first interface and to convert the commands to instructions for a cable reel module; and a first wireless transceiver module.

The system further comprises a cable reel module, the cable reel module comprising: a motor operated cable reel connected to a power source, the cable of the cable reel having a first end secured to a ship and a second end configured to attach to an ROV to control an ascent or descent of the ROV at a desired velocity, or to implement a stopping motion of the ROV; a second processor; and a second wireless transceiver module; and a second user interface comprising controls for operating the cable reel module including a control for initiating an emergency stop of the ROV.

The first and second processors are configured to communicate via the first and second wireless transceiver modules, and the second processor is configured to, in response to instructions received from the first processor, operate the motor of the cable reel to control an ascent, or descent, or stopping motion of an attached ROV.

Furthermore, the second processor is configured, in response to receiving instructions via the second user interface, to initiate a manual override of the cable reel motor operation, prioritising instructions received from the second user interface over instructions received from the first processor.

In some embodiments, the first processor is configured to send a signal containing instructions to the second processor for controlling the ascent or descent of the ROV based on one or more inputs received via the user interface.

In such embodiments, the user interface can comprise one or more control buttons, each corresponding to a cable reel control instruction.

In some embodiments, the remote control module and cable reel module each comprise a circuitry component allowing communication according to RS485 wireless communication standards.

In some embodiments, the remote control module and cable reel module each comprise one or more amplifiers for ensuring signals transmitted by the first and second wireless transceiver modules are received.

### BRIEF DESCRIPTION OF THE DRAWINGS

Various embodiments of the invention are disclosed in the following detailed description and accompanying drawings.

FIG. 1 illustrates a configuration of the control system of the present invention in a block diagram component view.

FIG. 2 illustrates a more specific example configuration of the control system and its operations in a block diagram components view.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

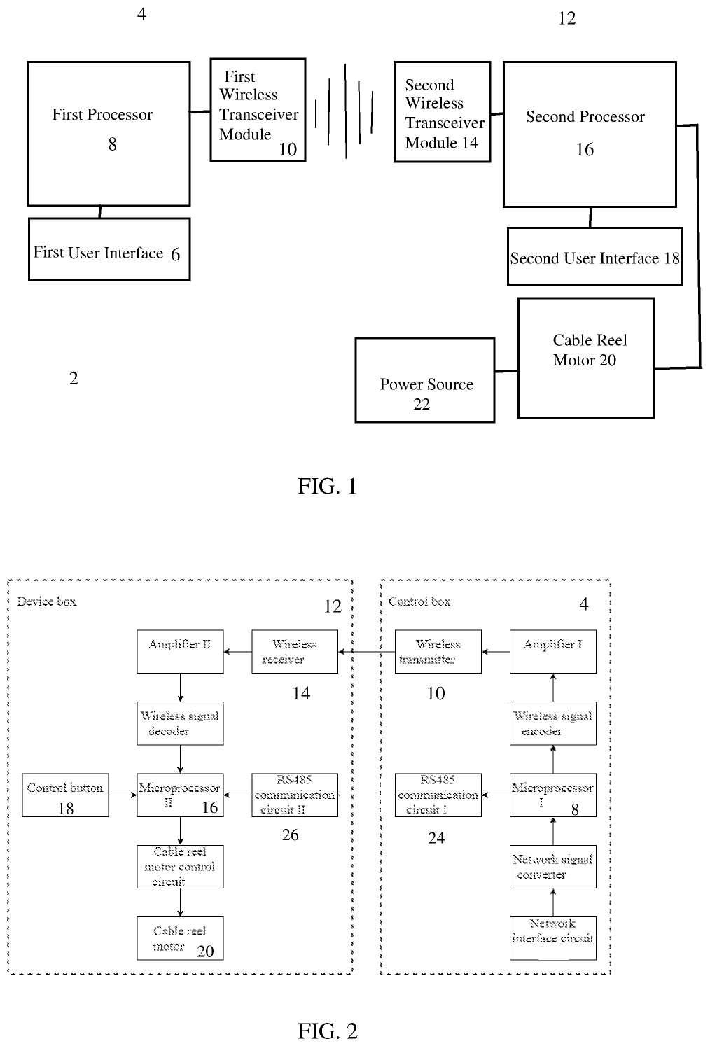

Referring to FIG. 1, a configuration of the control system 2 of the present invention is shown in a block diagram component view.

The control system 2 for controlling a cable operated ROV comprises a remote control module 4. The remote control module is a group of connected components, including a first user interface 6, a first processor 8, and a first wireless transceiver 10.

The user interface 6 may comprise one or more buttons for allowing a user to instruct the control system as to how they desire the ROV to move, as well as controlling various other operations of the ROV—for example, if the cable connects directly to the ROV processors and allows control of its functions then various surveying and exploration operations of the ROV could be controlled through the interface, from activating headlights to manipulating robotic arms.

The user interface could also comprise a touch screen interface display comprising one or more menus.

For example, the user may be able to select a desired motion type for the ROV from options such as ascent, descent, and stop. More specific motions such as emergency stop may also be available, and the user may even be able to select a velocity of descent, velocity of descent, or acceleration profile and depth level for the ROV trajectory.

In some embodiments a user could even instruct the control system to perform automated control of the ROV using information known about the current depth of the ocean floor, currents, information received from sensors, and other environmental factors.

The first processor 8 is configured to receive the instructions from the user interface 6 and determine one or more actions that the ROV should be controlled to perform. Having determined the one or more actions, the first processor 8 will generate a signal to be transmitted to the processor controlling the cable reel motor that determines the ROV movement under the water. The processor 8 forwards this signal to wireless transceiver module 10. Wireless transceiver module 10 is configured to send the signal to one or more other wireless transceiver modules. In some embodiments wireless transceiver 10 is only capable of sending signals. In other embodiments the wireless transceiver 10 may both send and receive wireless signals.

The wireless signal is sent to cable reel control module 12. Specifically, the signal is picked up by a second wireless transceiver module 14 comprising a part of cable reel control module 12, and the signal is forwarded to a processor 16 of the cable reel control module. The second processor 16 interprets the wireless signal to determine the one or more actions decided by the first processor

This may involve decoding the signal. Once the second processor 16 has decoded the signal and determined the one or more actions, it further determines whether the one or more actions require the cable to be extended, for example if the user desires the ROV to make a descent, or conversely if the cable should be retracted, for example if the user desires the ROV to make an ascent, also an instruction to stop the ROV would be interpreted as an instruction to lock rotation of the cable reel, etc. The rate at which the cable is extended or retracted may also be determined for slow and fast ascents and descents and the rate of descent or ascent may follow a predetermined profile based on known conditions and a desired trajectory for the ROV. The one or more actions could also include a stop action, where it is determined that no more cable should be extended or retracted and instead the rotation of the cable reel should be locked, for example to prevent the ROV from impacting an object that has been detected to prevent damage to the ROV. The stop action may be an emergency stop where rotation of the cable reel is immediately locked, or a gentle stop where the ascent or descent is first decelerated before locking the cable reel.

Once the second processor 16 has converted the one or more determined actions into instructions for controlling the cable reel, the instructions are forwarded to cable reel motor element 20, which controls a motor to perform the desired extension, retraction, or locking of the cable reel. The motor may be electric, or any other suitable type of motor, and is connected to a suitable power source 22.

The cable reel itself must be built to withstand the forces that it will experience from the weight of the ROV and the intense weather conditions that ships often traverse. Therefore it should be anchored to the ship in some manner as will be known to those skilled in the art. The cable itself may have an attachment at its end for connecting to various types of ROVs, alternatively it may have an ROV integrated to it. In some embodiments the cable is an electric cable that sends and receives signals from the ROV itself, and the control system 2 can have the further purpose of interfacing with the ROV controller to operate any number of its specific functionalities—these functionalities will depend on the type of ROV used but can include activation of headlights, sensors, and manipulation of robotic arms or of propellers to cause transverse motion of the ROV.

There may be some situations where the wireless communication between the first processor and the second processor breaks down. Furthermore, there may be some situations where an operator of the control module 4 is unable or unwilling to correctly control the ROV to perform the desired operations. For such eventualities, the control system 2 further comprises a second user interface 18 which is similar to the first interface 6 but which is part of the cable reel module itself and transmits instructions to the second processor 16 via a wired connection. The second user interface 18 may be in the form of one or more buttons, or in the form of a touch screen comprising one or more menus similar to the first user interface. Thus the second processor 16 may be configured, in response to receiving instructions via the second user interface 18, to initiate a manual override of the cable reel motor operation, prioritising instructions received from the second user interface 18 over instructions received from the first processor 8. The instructions that may be input to the user interface can comprise one or more of: releasing additional cable to control a descent of an ROV, retracting cable reel to control an ascent of an ROV, and locking the cable reel from rotating to initiate an emergency stop of an ROV. These features of the disclosed system increase the safety of the system for both operators and for expensive ROV apparatus that can be difficult to replace.

The operations of the disclosed control system thus enable flexible and automated control of an ROV conducting an operation. Ocean exploration is taken as an example, where an unmanned remotely operated submersible travels up to 4,000 meters down at the speed of 3-6 km/h under the sea—with different speeds appropriate for different depths, allowing velocity profiles for both descent and ascent to be pre-calculated and programmed in to the automated cable reel control system.

In the event that the unmanned remotely operated submersible detects a target and needs to stop or even emergency stop to avoid a collision, an operator can initiate such an emergency stop from the convenient location of a control tower where the remote control module 12 is located, and if communication with the remote operator is not effective or has broken down, the stop can be initiated from the cable reel control module itself using a manual override system.

Referring to FIG. 2, a more specific example configuration of the control system and its operations is shown in a block diagram components view.

As shown, the remote control module 4 and cable reel module 12 each comprise a circuitry component 24 and 26 allowing communication according to RS485 wireless communication standards. While this is the standard for this type of wireless communication, the use of RS485 wireless communication is only an example method, and the skilled person reading this disclosure will understand that any suitable type of wireless communication can be used.

Additionally, the specific components which allow for communication between the wireless transceivers are illustrated, each wireless transceiver comprising an amplified component and an encoder/decoder component, thus ensuring that signals can be properly sent and received between the two modules.

The remote control module 4 comprises a first interface such as a set of buttons or touchscreen menus, and also further includes a network interface circuit and a network signal converter, allowing a microprocessor 8 to interact with external networks. The system can thus be operated on-site or remotely, even from locations not aboard the ship on which the cable reel module 12 is installed.

After an instruction passes through the first interface or network interface circuit and is converted by the network signal converter, the microprocessor 8 controls the wireless signal encoder and the amplifier to encode and amplify a signal which is sent to the device box or cable reel control module 12.

The cable reel control module 12 includes an amplifier, a wireless signal decoder, a second microprocessor 16, and a cable reel motor control circuit configured to implement instructions from the microprocessors. The components are connected in series. The signal received by means of the wireless communication module 14 is amplified by the amplifier II and decoded by the wireless signal decoder, and is then transmitted to the microprocessor 16, and the microprocessor 16 controls the cable reel motor by means of the cable reel motor control circuit.

The device box or cable reel module 12 further includes a user interface in the form of control buttons 18 which are connected to the microprocessor 16. In the present example the control buttons include an emergency stop button, a manual/remote control switch button, a reel retraction button, and a reel extension button.

The apparatus is small in volume, can be arranged on various medium and small ships, and has good sea condition adaptability, thereby reducing the need for manual intervention and improving working efficiency. When manual operation is needed, the manual button/the remote control switch button can be pressed and the turn-on or turn-off functionality of the cable reel motor is directly controlled, this both increases the flexibility of the system and provides an in-built safety measure that can protect both operators and expensive ROV equipment.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the cable reel control system have been described in a specific manner referring to the illustrated embodiments, it is understood that the present invention can be applied to a wide variety of cable reel control solutions which fit within the scope and spirit of the claims. There are many alternative ways of implementing the invention.

While having been described specifically with respect to a microprocessors, it should be understood that the operations described herein may be carried out by any processor or computing environment. In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below. In addition, the operations shown in the figures, or as discussed herein, are identified using a particular nomenclature for ease of description and understanding, but other nomenclature is often used in the art to identify equivalent operations.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A wireless control system for a cable-operated ROV, the control system comprising:
a remote control module, the remote control module comprising:
a first user interface comprising controls for selecting a motion type for an ROV, the possible motion types including ascent, descent, and stopping motions, and the interface further comprising options for controlling an ascent velocity or descent velocity of the ROV;
a first processor configured to interpret control commands received via the first interface and to convert the commands to instructions for a cable reel module; and
a first wireless transceiver module;
a cable reel module, the cable reel module comprising:
a motor operated cable reel connected to a power source, the cable of the cable reel having a first end secured to a ship and a second end configured to attach to an ROV to control an ascent or descent of the ROV at a desired velocity, or to implement a stopping motion of the ROV;
a second processor;
a second wireless transceiver module; and
a second user interface comprising controls for operating the cable reel module including a control for initiating an emergency stop of the ROV;
wherein the first and second processors are configured to communicate via the first and second wireless transceiver modules, and wherein the second processor is configured to, in response to instructions received from the first processor, operate the motor of the cable reel to control an ascent, descent, or stopping motion of an attached ROV;
wherein the second processor is configured, in response to receiving instructions via the second user interface, to initiate a manual override of the cable reel motor operation, prioritising instructions received from the second user interface over instructions received from the first processor.

2. A control system according to claim 1, wherein the first processor is configured to send a signal containing instructions to the second processor for controlling the ascent or descent of the ROV based on one or more inputs received via the user interface.

3. A control system according to any preceding claim, wherein the instructions that may be input to the user interface comprise one or more of: releasing additional cable to control a descent of an ROV, retracting cable reel to control an ascent of an ROV, and locking the cable reel from rotating to initiate an emergency stop of an ROV.

4. A control system according to claim 3, wherein the user interface comprises one or more control buttons, each corresponding to a cable reel control instruction.

5. A control system according to any preceding claim, wherein the remote control module and cable reel module each comprise a circuitry component allowing communication according to RS485 wireless communication standards.

6. A control system according to any preceding claim, wherein the remote control module and cable reel module each comprise one or more amplifiers for ensuring signals transmitted by the first and second wireless transceiver modules are received.
